(19) United States
(12) Patent Application Publication
(10) Pub. No.: US 2025/0058506 A1
(43) Pub. Date: Feb. 20, 2025

(54) INJECTION MOLDING APPARATUS AND COTTER

(71) Applicants: HYUNDAI MOTOR COMPANY, Seoul (KR); KIA CORPORATION, Seoul (KR); HANGUK MOLD CO., LTD, Ulsan (KR)

(72) Inventors: Kyu Young LEE, Ulsan (KR); Suk Joo HONG, Suwon-si (KR); Jung Hwan PARK, Ulsan (KR); Eui Hwan SON, Ulsan (KR); Min Woo CHU, Ulsan (KR); Byoung Jin KWON, Ulsan (KR); Ji Hun KIM, Ulsan (KR)

(21) Appl. No.: 18/503,367

(22) Filed: Nov. 7, 2023

(30) Foreign Application Priority Data
Aug. 18, 2023 (KR) 10-2023-0108578

(51) Int. Cl. B29C 45/26; B29C 45/04; B29C 45/37

(52) U.S. Cl. CPC B29C 45/2606; B29C 45/0416; B29C 45/37; B29C 2045/4078

(57) ABSTRACT

The present disclosure provides an injection molding apparatus including a first mold, a second mold configured to be relatively movable toward or away from the first mold and define a cavity for forming a molded body collectively with the first mold, a stripper provided between the first mold and the second mold and configured to separate the molded body from the first mold, a first cotter block provided on the stripper, and a second cotter block provided on the second mold, configured to be rollable relative to the first cotter block, and configured to align the second mold with the first mold collectively with the first cotter block, thereby obtaining an advantageous effect of reducing a defect rate related to the molded body and improving quality and productivity.

### CROSS-REFERENCE TO RELATED APPLICATION

This application claims priority to and the benefit of Korean Patent Application No. 10-2023-0108578, filed in the Korean Intellectual Property Office, on Aug. 18, 2023, the entire contents of which are incorporated herein by reference.

### TECHNICAL FIELD

The present disclosure relates to a pressure vessel assembly and a pressure vessel protector, and more particularly, to an injection molding apparatus and a cotter, which are capable of reducing a defect rate related to a molded body and improving quality and productivity.

### BACKGROUND

A hydrogen electric vehicle (e.g., a passenger vehicle or a commercial vehicle) is configured to autonomously generate electricity by a chemical reaction between hydrogen and oxygen and travel by operating a motor. More specifically, the hydrogen electric vehicle includes a pressure vessel configured to store hydrogen (H₂), a fuel cell stack configured to produce electricity by an oxidation-reduction reaction between hydrogen and oxygen (O₂), various types of devices configured to discharge produced water, a battery configured to store the electricity produced by the fuel cell stack, a controller configured to convert and control the produced electricity, and a motor configured to generate driving power.

A TYPE 4 pressure vessel may be used as the pressure vessel of the hydrogen electric vehicle. The TYPE 4 pressure vessel may include a liner (made of e.g., a nonmetallic material), and a carbon fiber layer made by winding a carbon fiber composite material around an outer surface of the liner.

In some cases, the liner of the TYPE 4 pressure vessel may be manufactured by manufacturing two liners having approximately dome shapes by injection molding and then joining the two liners (e.g., thermal bonding or laser welding).

For example, the liner may be manufactured by injecting a raw material into a cavity defined between a first mold having a molding protrusion and a second mold having a molding groove. After the second mold is separated from the first mold, the liner remaining on the molding protrusion of the first mold may be extracted from the molding protrusion of the first mold by a stripper.

In some cases, because the liner has a dome shape, the liner may have a thickness deviation unless the first mold and the second mold are accurately aligned during the injection molding process of manufacturing the liner. Therefore, the first mold and the second mold needs to be accurately aligned during the injection molding process of manufacturing the liner.

In some cases, a method may be applied to align a first mold and a second mold by a first cotter block mounted on a stripper and a second cotter block mounted on the second mold. In some cases, the first cotter block and the second cotter block may be jammed (a situation in which the first cotter block and the second cotter block are not smoothly separated), where the stripper moves together with the second mold (in a direction away from the first mold) when the second mold is separated from the first mold. In some cases, an end of the liner remaining on the molding protrusion of the first mold (an end of the liner adjacent to the stripper) may be abnormally pressed by the stripper, which causes deformation of and damage to the liner.

Therefore, recently, various studies have been conducted to reduce a defect rate related to the liner and improve quality and productivity, but the study results are still insufficient. Accordingly, there is a need to develop a technology to reduce a defect rate related to the liner and improve quality and productivity.

### SUMMARY

The present disclosure describes an injection molding apparatus and a cotter, which are capable of reducing a defect rate related to a molded body and improving quality and productivity.

The present disclosure further describes an injection molding apparatus and a cotter that can minimize deformation of and damage to a molded body caused when a cotter is jammed during an injection molding process of manufacturing a molded body.

The present disclosure further describes an injection molding apparatus and a cotter that can reduce a defect rate during an injection molding process of manufacturing a liner for a hydrogen tank and improve quality and productivity.

The present disclosure also describes an injection molding apparatus and a cotter that can reduce manufacturing costs and improve production efficiency.

In order to achieve the above-mentioned objects, the present disclosure provides an injection molding apparatus including: a first mold; a second mold configured to be relatively movable toward or away from the first mold and define a cavity for forming a molded body collectively with the first mold; a stripper provided between the first mold and the second mold and configured to separate the molded body from the first mold; a first cotter block provided on the stripper; and a second cotter block provided on the second mold, configured to be rollable relative to the first cotter block, and configured to align the second mold with the first mold collectively with the first cotter block.

The can injection molding apparatus help reduce a defect rate related to the molded body and improve productivity.

In some implementations, the second cotter block may roll relative to the first cotter block, which may prevent the first cotter block and the second cotter block from being jammed. Therefore, it is possible to obtain an advantageous effect of suppressing a situation in which the stripper moves together with the second mold (moves away from the first mold) when the second mold is separated from the first mold. Further, it is possible to obtain an advantageous effect of minimizing deformation of and damage to the molded body caused by the movement of the stripper.

The first cotter block may have various structures capable of aligning the second mold with the first mold collectively with the second cotter block.

In some implementations, the injection molding apparatus may include: a cotter protrusion provided on the first cotter block; and a cotter groove provided in the second cotter block so that the cotter protrusion is inserted into the cotter groove, in which the cotter protrusion rolls relative to the cotter groove.

The rolling motion of the cotter protrusion relative to the cotter groove may be implemented in various ways in accordance with conditions and design specifications.

In some implementations, the second cotter block may include: a block main body provided on the second mold and having the cotter groove; and a cotter bearing provided on the block main body so as to be exposed to the cotter groove and configured to rollably support the cotter protrusion inserted into the cotter groove.

In some implementations, the cotter bearing may include a first bearing member, and a second bearing member provided adjacent to the first bearing member and configured to rollably support the cotter protrusion collectively with the first bearing member.

As described above, in some implementations, the first bearing member and the second bearing member rollably support the cotter protrusion. Therefore, it is possible to obtain an advantageous effect of more stably ensuring the insertion and extraction of the cotter protrusion with respect to the cotter groove.

The first and second cotter blocks may be variously changed in numbers and positions in accordance with conditions and design specifications.

In some implementations, the first cotter blocks may be independently provided on a stripper-first lateral surface, a stripper-second lateral surface, a stripper-third lateral surface, and a stripper-fourth lateral surface of the stripper, and the second cotter blocks may be independently provided on a mold-first lateral surface, a mold-second lateral surface, a mold-third lateral surface, and a mold-fourth lateral surface of the second mold so as to correspond to the first cotter block.

As described above, in some implementations, the first cotter blocks and the second cotter blocks are respectively provided on four surfaces (or four sides) of each of the stripper and the second mold. Therefore, it is possible to obtain an advantageous effect of further minimizing the movement of the second mold relative to the first mold (e.g., the movement in the X-axis direction and the movement in the Y-axis direction) and more precisely aligning the first mold and the second mold.

In some implementations, a draft (draft angle) of the second cotter block with respect to the first cotter block may be set to 0 degree (0 degree based on a side wall surface of the cotter groove) based on the direction of the movement of the second cotter block relative to the first cotter block.

This is based on the fact that as the draft of the second cotter block with respect to the first cotter block increases, the insertion or extraction of the cotter protrusion with respect to the cotter groove may be easily implemented, but a degree of alignment of the second cotter block with respect to the first cotter block (a degree of alignment of the second mold with respect to the first mold) deteriorates. In some implementations, the draft of the second cotter block with respect to the first cotter block is set to 0 degree, which makes it possible to obtain an advantageous effect of further improving a degree of alignment of the second cotter block with respect to the first cotter block.

Moreover, as the draft of the second cotter block with respect to the first cotter block decreases, the first cotter block and the second cotter block are increasingly likely to be jammed. However, in some implementations, because the second cotter block is rollable relative to the first cotter block, the smooth movement of the second cotter block relative to the first cotter block may be ensured even though the draft of the second cotter block with respect to the first cotter block is set to 0 degree. Therefore, it is possible to obtain an advantageous effect of preventing the first cotter block and the second cotter block from being jammed.

### BRIEF DESCRIPTION OF THE DRAWINGS

FIG. 1 is a view showing an example of an injection molding apparatus.

FIG. 2 is a view showing an example state in which a first mold and a second mold of the injection molding apparatus are separated.

FIG. 3 is a view showing an example of a stripper of the injection molding apparatus.

FIGS. 4 to 6 are views showing an example of a cotter.

FIG. 7 is a view showing an example state in which a molded body is separated when a first cotter block and a second cotter block are jammed.

### DETAILED DESCRIPTION

Hereinafter, one or more exemplary implementations of the present disclosure will be described in detail with reference to the accompanying drawings.

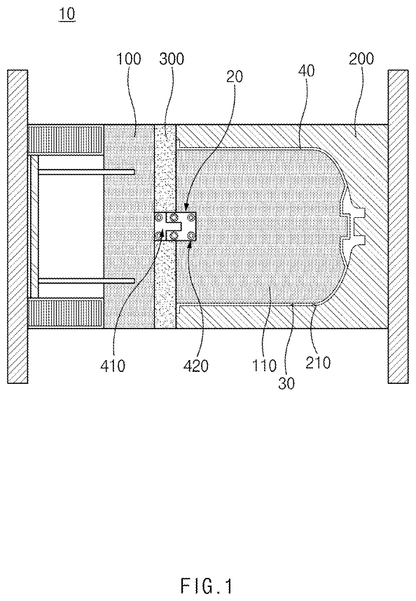

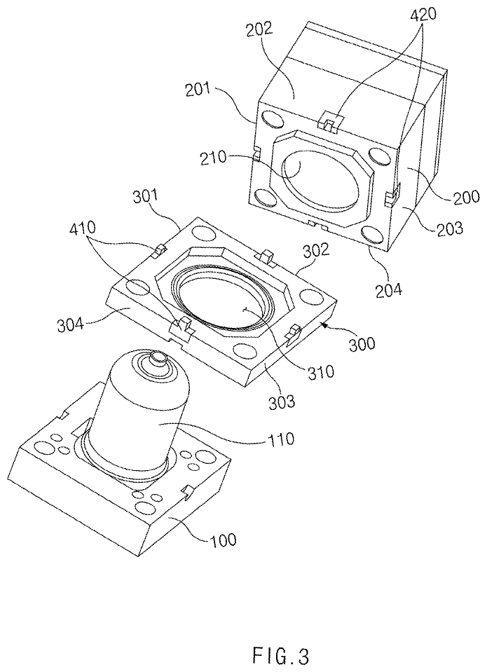

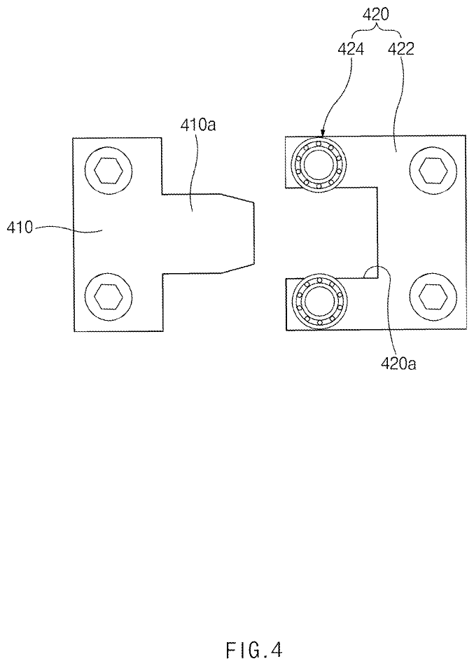

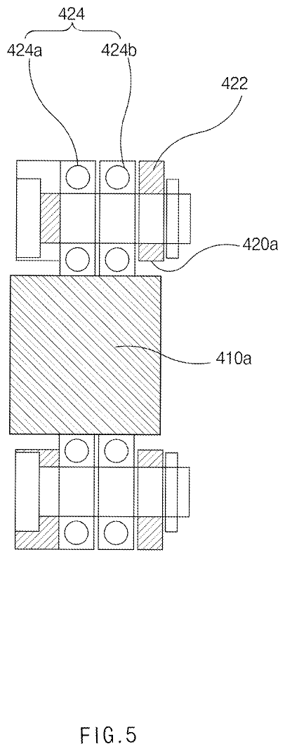

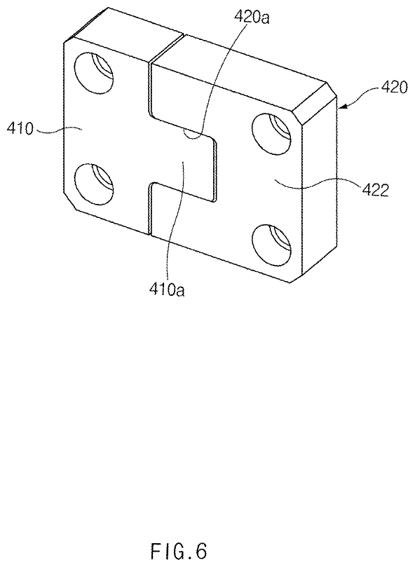

With reference to FIGS. 1 to 6, an injection molding apparatus 10 includes a first mold 100, a second mold 200 configured to be relatively movable toward or away from the first mold 100 and define a cavity 30 for forming a molded body 40 collectively with the first mold 100, a stripper 300 provided between the first mold 100 and the second mold 200 and configured to separate the molded body 40 from the first mold 100, a first cotter block 410 provided on the stripper 300, and a second cotter block 420 provided on the second mold 200, configured to be rollable relative to the first cotter block 410, and configured to align the second mold 200 with the first mold 100 collectively with the first cotter block 410.

In some implementations, the injection molding apparatus 10 may be used to form various molded bodies 40 in accordance with conditions and design specifications. The present disclosure is not restricted or limited by the type and structure of the molded body 40.

For example, the injection molding apparatus 10 may be used to manufacture a liner for a hydrogen tank.

The first mold 100 and the second mold 200 collectively define the cavity 30 corresponding to the molded body 40.

The first mold 100 may have various structures and shapes in accordance with conditions and design specifications. The present disclosure is not restricted or limited by the structure and shape of the first mold 100.

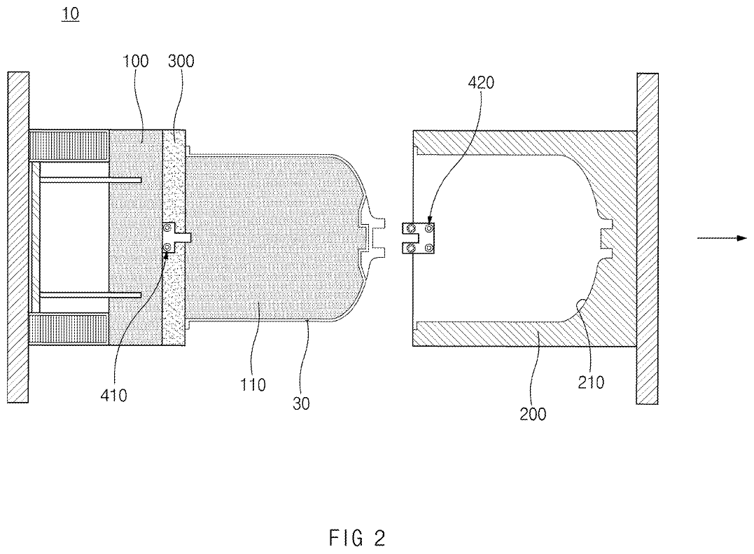

For example, the first mold 100 may be provided in the form of an approximately quadrangular box. A molding protrusion 110 may protrude from one surface (a right surface based on FIG. 2) of the first mold 100.

For example, the molding protrusion 110 may have a dome shape corresponding to an inner surface of the liner. The molding protrusion 110 may be variously changed in structure and shape in accordance with conditions and design specifications. The present disclosure is not restricted or limited by the structure and shape of the molding protrusion 110.

The second mold 200 is configured to be relatively movable toward or away from the first mold 100 (in a leftward/rightward direction based on FIG. 2). The second mold 200 and the first mold 100 collectively define the cavity 30 for forming the molded body 40.

The second mold 200 may have various structures and shapes in accordance with conditions and design specifications. The present disclosure is not restricted or limited by the structure and shape of the second mold 200.

For example, the second mold 200 may be provided in the form of an approximately quadrangular box. A molding groove 210 may be recessed in one surface (a left surface based on FIG. 2) of the second mold 200 that faces the first mold 100.

For example, the molding groove 210 may have a dome shape corresponding to an outer surface of the liner. The molding groove 210 may be variously changed in structure and shape in accordance with conditions and design specifications. The present disclosure is not restricted or limited by the structure and shape of the molding groove 210.

With reference to FIGS. 1 to 3, the stripper 300 is configured to separate (extract) the molded body 40 from the first mold 100. The stripper 300 is provided between the first mold 100 and the second mold 200 and configured to be relatively movable toward or away from the first mold 100 (in the leftward/rightward direction based on FIG. 2).

That is, the molded body 40 (e.g., the liner) may be formed by injecting a raw material into the cavity 30 defined between the molding protrusion 110 of the first mold 100 and the molding groove 210 of the second mold 200. After the second mold 200 is separated from the first mold 100 (the second mold moves rightward relative to the first mold based on FIG. 2), the molded body 40 (e.g., the liner) remaining on the molding protrusion 110 of the first mold 100 may be extracted from the molding protrusion 110 of the first mold 100 by the stripper 300.

The stripper 300 may have various structures capable of extracting (separating) the molded body 40 from the molding protrusion 110 of the first mold 100. The present disclosure is not restricted or limited by the structure of the stripper 300.

For example, the stripper 300 may be provided in the form of an approximately quadrangular box. A through-hole 310 may be provided in an approximately central portion of the stripper 300, and the molding protrusion 110 may be accommodated in the through-hole 310 so as to enter or exit the through-hole 310 (move in the through-hole 310).

After the second mold 200 is separated from the first mold 100, the molded body 40 (e.g., the liner) remaining on the molding protrusion 110 of the first mold 100 may be extracted from the molding protrusion 110 of the first mold 100 as the stripper 300 moves away from the first mold 100 (in the rightward direction based on FIG. 2).

With reference to FIGS. 1 to 6, in some implementations, the injection molding apparatus 10 may include a cotter 20 used to align the second mold 200 with the first mold 100.

For example, the present disclosure describes the configuration in which the second mold 200 is aligned with the first mold 100 may be defined as a configuration in which the second mold 200 is accurately positioned (matched) in a predetermined posture (predetermined coupling position) with respect to the first mold 100. A movement of the second mold 200 (e.g., a movement in an X-axis direction and a movement in a Y-axis direction) relative to the first mold 100 may be restricted by the cotter.

More specifically, the cotter 20 includes the first cotter block 410 provided on the stripper 300, and the second cotter block 420 provided on the second mold 200 and configured to be rollable relative to the first cotter block 410.

The first cotter block 410 may have various structures capable of being temporarily fastened to the second cotter block 420 and aligning the second mold 200 with the first mold 100 collectively with the second cotter block 420. The present disclosure is not restricted or limited by the structure of the first cotter block 410.

For example, the first cotter block 410 may be provided in the form of an approximately quadrangular block. A cotter protrusion 410a having an approximately quadrangular column shape may protrude from one surface of the first cotter block 410 that faces the second mold 200 (second cotter).

Further, the first cotter block 410 may be integrally fastened (fixed) to a lateral surface of the stripper 300 by a typical fastening member (fastening bolt).

The second cotter block 420 may have various structures capable of being temporarily fastened to the first cotter block 410 and rollable relative to the first cotter block 410. The present disclosure is not restricted or limited by the structure of the second cotter block 420.

In some implementations, a cotter groove 420a may be recessed in one surface of the second cotter block 420, and the cotter protrusion 410a may be inserted into the cotter groove 420a. The cotter protrusion 410a may roll relative to the cotter groove 420a.

The rolling motion of the cotter protrusion 410a relative to the cotter groove 420a may be implemented in various ways in accordance with conditions and design specifications.

In some implementations, the second cotter block 420 may include a block main body 422 provided on the second mold 200 and having the cotter groove 420a, and cotter bearings 424 provided on the block main body 422, exposed to the cotter groove 420a, and configured to rollably support the cotter protrusion 410a inserted into the cotter groove 420a.

The block main body 422 may be provided in the form of an approximately quadrangular block. The cotter groove 420a may be recessed in one surface of the block main body 422 that faces the first mold 100 (first cotter). For example, the cotter groove 420a may be provided in the form of a quadrangular groove corresponding to the cotter protrusion 410a.

Further, the block main body 422 may be integrally fastened (fixed) to a lateral surface of the second mold 200 by a typical fastening member (fastening bolt).

Various bearings (e.g., a ball bearing or a roller bearing) capable of rollably supporting the cotter protrusion 410a may be used as the cotter bearing 424. The present disclosure is not restricted or limited by the type and structure of the cotter bearing 424.

In some implementations, the cotter bearings 424 may include a first bearing member 424a, and a second bearing member 424b provided adjacent to the first bearing member 424a and configured to rollably support the cotter protrusion 410a collectively with the first bearing member 424a.

In some examples, the first bearing member 424a and the second bearing member 424b rollably support the cotter protrusion 410a. Therefore, it is possible to obtain an advantageous effect of more stably ensuring the insertion and extraction of the cotter protrusion 410a with respect to the cotter groove 420a.

In some implementations, a deep-groove ball bearing having an outer diameter of 26 mm and an inner diameter of 10 mm may be used as the first bearing member 424a and the second bearing member 424b.

In some examples, the second cotter block 420 may roll relative to the first cotter block 410, which may prevent the first cotter block 410 and the second cotter block 420 from being jammed. Therefore, it is possible to obtain an advantageous effect of suppressing a situation in which the stripper 300 moves together with the second mold 200 (moves away from the first mold) when the second mold 200 is separated from the first mold 100. Further, it is possible to obtain an advantageous effect of minimizing deformation of and damage to the molded body 40 caused by the movement of the stripper 300.

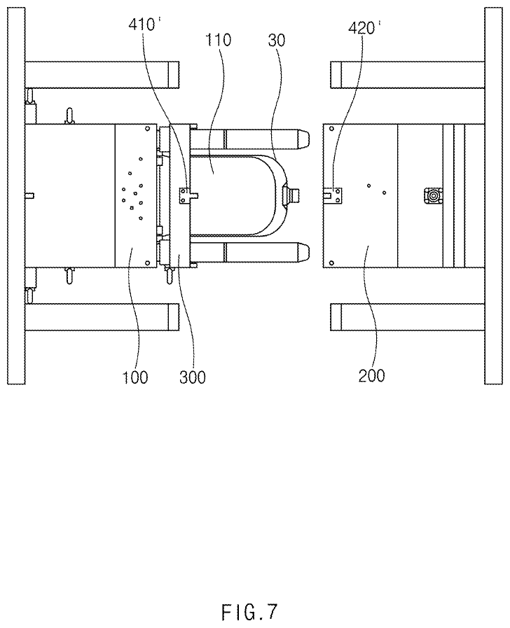

That is, with reference to FIG. 7, in case that a first cotter block 410′ and a second cotter block 420′, which are not allowed to roll relative to each other, are used, there is a problem in that the stripper 300 moves together with the second mold 200 (moves away from the first mold) when the second mold 200 is separated from the first mold 100 in case that the first cotter block 410′ and the second cotter block 420′ are jammed (a situation in which the first cotter block and the second cotter block are not smoothly separated). For this reason, there is a problem in that the end (the end adjacent to the stripper) of the liner remaining on the molding protrusion 110 of the first mold 100 is abnormally pressed by the stripper 300, which causes deformation of and damage to the liner.

In some implementations, the second cotter block 420 may roll relative to the first cotter block 410, which makes it possible to obtain an advantageous effect of preventing the first cotter block 410 and the second cotter block 420 from being jammed.

In this application, the examples have been described in which the cotter bearings 424 include the two bearing members (the first bearing member and the second bearing member). However, in some implementations, the cotter bearing may be configured as a single bearing member, or three or more bearing members may be provided.

In addition, in the present disclosure, the examples have been described in which the cotter bearing 424 is provided in the cotter groove 420a, and the cotter protrusion 410a is in rollable contact with the cotter bearing 424. However, in some implementations, the cotter bearing may be provided on the lateral surface of the cotter protrusion, and the cotter bearing may be in rollable contact with an inner wall surface of the cotter groove.

In addition, in the present disclosure, the examples have been described in which the cotter bearing 424 is provided in the cotter groove 420a to implement the rolling motion of the cotter protrusion 410a relative to the cotter groove 420a. However, in some implementations, a bushing made of a lubricating material such as engineering plastic may be used instead of the cotter bearing.

The first cotter block 410 and the second cotter block 420 may be variously changed in number and position in accordance with conditions and design specifications. The present disclosure is not restricted or limited by the number and position of the first cotter block 410 and the second cotter block 420.

In some implementations, the first cotter blocks 410 may be independently provided on a stripper-first lateral surface 301, a stripper-second lateral surface 302, a stripper-third lateral surface 303, and a stripper-fourth lateral surface 304 of the stripper 300. The second cotter blocks 420 may be independently provided on a mold-first lateral surface 201, a mold-second lateral surface 202, a mold-third lateral surface 203, and a mold-fourth lateral surface 204 of the second mold 200 so as to correspond to the first cotter blocks 410.

As described above, in some implementations, the first cotter blocks 410 and the second cotter blocks 420 are respectively provided on four surfaces (or four sides) of each of the stripper 300 and the second mold 200. Therefore, it is possible to obtain an advantageous effect of further minimizing the movement of the second mold 200 relative to the first mold 100 (e.g., the movement in the X-axis direction and the movement in the Y-axis direction) and more precisely aligning the first mold 100 and the second mold 200.

In the present disclosure, the examples have been described in which the injection molding apparatus 10 includes the four first cotter blocks 410 and the four second cotter blocks 420. However, in some implementations, the injection molding apparatus may include three or fewer first cotter blocks and three or fewer second cotter blocks or include five or more first cotter blocks and five or more second cotter blocks.

In some implementations, a draft (draft angle) of the second cotter block 420 with respect to the first cotter block 410 may be set to 0 degrees (0 degrees with respect to a side wall surface of the cotter groove) based on the direction of the movement of the second cotter block 420 relative to the first cotter block 410.

This is based on the fact that as the draft of the second cotter block 420 with respect to the first cotter block 410 increases, the insertion or extraction of the cotter protrusion 410a with respect to the cotter groove 420a may be easily implemented, but a degree of alignment of the second cotter block 420 with respect to the first cotter block 410 (a degree of alignment of the second mold with respect to the first mold) deteriorates. In some implementations, the draft of the second cotter block 420 with respect to the first cotter block 410 is set to 0 degrees, which makes it possible to obtain an advantageous effect of further improving a degree of alignment of the second cotter block 420 with respect to the first cotter block 410.

Moreover, as the draft of the second cotter block 420 with respect to the first cotter block 410 decreases, the first cotter block 410 and the second cotter block 420 are increasingly likely to be jammed. However, in some implementations, because the second cotter block 420 is rollable relative to the first cotter block 410, the smooth movement of the second cotter block 420 relative to the first cotter block 410 may be ensured even though the draft of the second cotter block 420 with respect to the first cotter block 410 is set to 0 degrees. Therefore, it is possible to obtain an advantageous effect of preventing the first cotter block 410 and the second cotter block 420 from being jammed.

As described above, in some implementations, it is possible to obtain an advantageous effect of reducing a defect rate related to the molded body and improving the quality and productivity.

In particular, in some implementations, it is possible to obtain an advantageous effect of minimizing deformation of and damage to the molded body caused when the cotter is jammed during the injection molding process of manufacturing the molded body.

In some implementations, it is possible to obtain an advantageous effect of reducing a defect rate during the injection molding process of manufacturing the liner for a hydrogen tank, thereby improving the quality and productivity.

In addition, in some implementations, it is possible to obtain an advantageous effect of reducing the manufacturing costs and improving the production efficiency.

While the implementations have been described above, the implementations are just illustrative and not intended to limit the present disclosure. It can be appreciated by those skilled in the art that various modifications and applications, which are not described above, may be made to the present implementation without departing from the intrinsic features of the present implementation. For example, the respective constituent elements specifically described in the implementations may be modified and then carried out. Further, it should be interpreted that the differences related to the modifications and applications are included in the scope of the present disclosure defined by the appended claims.

What is claimed is:

1. An injection molding apparatus comprising:
a first mold;
a second mold configured to be moved toward and away from the first mold, the second mold being configured to define a cavity for forming a molded body with the first mold;
a stripper disposed between the first mold and the second mold and configured to separate the molded body from the first mold;
a first cotter block disposed at the stripper; and
a second cotter block disposed at the second mold and configured to align the second mold with the first mold with the first cotter block, wherein at least a portion of the second cotter block is configured to roll relative to the first cotter block.

2. The injection molding apparatus of claim 1, wherein the first cotter block comprises a cotter protrusion,
wherein the second cotter block defines a cotter groove configured to receive the cotter protrusion therein, and
wherein the cotter protrusion is configured to roll relative to the cotter groove.

3. The injection molding apparatus of claim 2, wherein the second cotter block comprises:
a block main body that is disposed at the second mold and defines the cotter groove; and
at least one cotter bearing disposed at the block main body and exposed to the cotter groove, the cotter bearing being configured to rollably support the cotter protrusion to be inserted into the cotter groove.

4. The injection molding apparatus of claim 3, wherein the at least one cotter bearing comprises a first bearing and a second bearing that are configured to rollably support the cotter protrusion.

5. The injection molding apparatus of claim 1, wherein the stripper comprises a plurality of first cotter blocks including the first cotter block, the plurality of first cotter blocks being disposed at a stripper-first lateral surface, a stripper-second lateral surface, a stripper-third lateral surface, and a stripper-fourth lateral surface of the stripper, respectively, and
wherein the second mold comprises a plurality of second cotter blocks including the second cotter block, the plurality of second cotter blocks being disposed at a mold-first lateral surface, a mold-second lateral surface, a mold-third lateral surface, and a mold-fourth lateral surface of the second mold, respectively, each of the plurality of second cotter blocks being configured to couple to one of the plurality of first cotter blocks.

6. The injection molding apparatus of claim 1, wherein the first mold comprises a molding protrusion,
wherein the second mold defines a molding groove corresponding to the molding protrusion, and
wherein the first mold and the second mold are configured to define the cavity between the molding protrusion and the molding groove.

7. The injection molding apparatus of claim 1, wherein the second cotter block defines a draft angle with respect to the first cotter block, the draft angle being zero degrees with respect to a direction of movement of the second cotter block relative to the first cotter block.

8. The injection molding apparatus of claim 1, wherein the molded body includes a liner for a hydrogen tank.

9. A cotter configured to align a first mold and a second mold of an injection molding apparatus, the injection molding apparatus including a stripper disposed between the first mold and the second mold and configured to separate a molded body from the first mold, the cotter comprising:
a first cotter block disposed at the stripper; and
a second cotter block disposed at the second mold, wherein at least a portion of the second cotter block is configured to roll relative to the first cotter block.

10. The cotter of claim 9, wherein the first cotter block comprises a cotter protrusion,
wherein the second cotter block defines a cotter groove configured to receive the cotter protrusion therein, and
wherein the cotter protrusion is configured to roll relative to the cotter groove.

11. The cotter of claim 10, wherein the second cotter block comprises:
a block main body that is disposed at the second mold and defines the cotter groove; and
at least one cotter bearing disposed at the block main body and exposed to the cotter groove, the cotter bearing being configured to rollably support the cotter protrusion to be inserted into the cotter groove.

12. The cotter of claim 11, wherein the at least one cotter bearing comprises a first bearing and a second bearing that are configured to rollably support the cotter protrusion.

13. The cotter of claim 12, wherein the first bearing and the second bearing protrudes through inner surfaces of the cotter groove that face each other, and
wherein the cotter protrusion is configured to contact the first bearing and the second bearing and rollably move between the first bearing and the second bearing.

14. The cotter of claim 9, further comprising:
a plurality of first cotter blocks including the first cotter block, the plurality of first cotter blocks being disposed at a stripper-first lateral surface, a stripper-second lateral surface, a stripper-third lateral surface, and a stripper-fourth lateral surface of the stripper, respectively; and
a plurality of second cotter blocks including the second cotter block, the plurality of second cotter blocks being disposed at a mold-first lateral surface, a mold-second lateral surface, a mold-third lateral surface, and a mold-fourth lateral surface of the second mold, respectively, each of the plurality of second cotter blocks being configured to couple to one of the plurality of first cotter blocks.

15. The cotter of claim 9, wherein the second cotter block defines a draft angle with respect to the first cotter block, the draft angle being zero degrees with respect to a direction of movement of the second cotter block relative to the first cotter block.
